(19) United States
(12) Patent Application Publication
(10) Pub. No.: US 2026/0273738 A1
(43) Pub. Date: Sep. 17, 2026

(54) HANDHELD DEVICE FOR ROBOTIC TRAINING DATA COLLECTION

(71) Applicant: xdof, Inc., Berkeley, CA (US)

(72) Inventors: Shiyao Philipp Wu, Berkeley, CA (US); Ding Jin, Berkeley, CA (US); Yide Shentu, Berkeley, CA (US); David Tse, Berkeley, CA (US); David Guo, Berkeley, CA (US)

(21) Appl. No.: 19/565,041

(22) Filed: Mar. 12, 2026

Related U.S. Application Data
(60) Provisional application No. 63/770,577, filed on Mar. 12, 2025.

(51) Int. Cl. B25J 9/16; B25J 13/02

(52) U.S. Cl. CPC B25J 9/163; B25J 13/02

(57) ABSTRACT

A handheld device and system for robotic training data collection are disclosed. The device includes an end effector actuated by a pair of squeeze levers that a user presses together and apart to open and close gripper fingers. One or more sensors, such as a rotary encoder, position-tracking sensor, vision sensor, or tactile sensor, collect multimodal training data during manipulation of objects. The device communicates the captured data to a computing system configured to process the data and train an artificial intelligence model for robotic control.

### CROSS-REFERENCE TO RELATED APPLICATIONS

This application claims priority to U.S. Provisional Patent Application No. 63/770,577 titled “HANDHELD DEVICE FOR ROBOTIC TRAINING DATA COLLECTION,” filed Mar. 12, 2025, the contents of which are incorporated by reference in its entirety for all purposes.

### BACKGROUND

The field of robotics suffers from a shortage of large-scale, high-quality training data. Unlike computer vision or language processing, where datasets can be scraped from the internet, robotic tasks often utilize real-world demonstrations and sensor measurements. Collecting such data is labor-intensive and often specialized for a specific robot or environment, making it difficult to develop models that generalize to new tasks or settings. Existing systems for collecting data often lack robust sensor suites. As a result, the datasets produced by these systems are insufficient for training the sophisticated models needed to handle the diverse and dynamic challenges of real-world robotics.

Additionally, existing data-collection tools frequently have ergonomic limitations. Many require awkward gripping postures, rely on small or unintuitive controls, or force the user to maintain unnatural wrist or finger positions for extended periods. Furthermore, existing data collection interfaces often lack an intuitive mapping between human hand motion and robotic end-effector behavior. For example, designs that require a trigger-pull actuation do not correspond naturally to gripping motions performed by a robotic gripper. As a result, users may struggle to produce consistent demonstrations, and the collected data may include unintended variance or timing irregularities.

### SUMMARY

The disclosed technology describes a handheld device for robotic training data collection that enables users to perform natural, intuitive grasping motions while generating high-quality multimodal training data. The device includes an end effector actuated by a pair of ergonomically shaped squeeze levers whose movement directly mirrors a human grasp, reducing fatigue and improving control compared to handheld tools that rely on awkward triggers or non-intuitive actuation mechanisms. A gear-rack and circular-gear translation system, coupled with sensors such as a rotary encoder, tactile sensor, vision sensor, and position-tracking sensor, captures robust information about hand motion, object interaction, and device pose. By combining ergonomic lever-based actuation with rich, synchronized sensing, the device overcomes limitations of existing data-collection solutions and supports the creation of more consistent, scalable, and realistic training datasets for robotic manipulation models.

These and other features and aspects of various examples may be understood in view of the following detailed discussion and accompanying drawings.

### BRIEF DESCRIPTION OF THE DRAWINGS

FIG. 1 illustrates a robotic training environment in an implementation.

FIG. 2 illustrates a handheld device in an implementation.

FIG. 3 illustrates an exploded view of the handheld device in an implementation.

FIGS. 4A illustrates the handheld device in an open position according to an implementation.

FIG. 4B illustrates the handheld device in a closed position according to an implementation.

FIG. 5 illustrates an end effector of the handheld device in an implementation.

FIG. 6 illustrates a sensor module of the handheld device in an implementation.

FIG. 7 illustrates a process for operating the handheld device in an implementation.

FIG. 8 illustrates a computing system suitable for implementing the various operational environments, architectures, environments, processes, scenarios, sequences, and frameworks discussed below with respect to the other Figures.

### DETAILED DESCRIPTION

The disclosure describes a handheld device for collecting robotic training data through natural, human-performed operations. In general, the device includes an end effector configured to grasp objects, a pair of squeeze levers that a user brings together and apart to actuate the end effector between open and closed positions, and one or more sensors that capture multimodal information during manipulation. The device is shaped and balanced to be operated comfortably over extended sessions, and to produce consistent demonstrations with reduced fatigue. A user-actuatable control on the handle can initiate or mark data collection, and a biasing element can urge the levers toward an open position of the end effector to provide predictable “at-rest” behavior and crisp release of objects.

The device utilizes a squeeze-lever mechanism according to some implementations. Unlike trigger-pull or button-press interfaces, the squeeze levers are arranged so that the user’s hand motion closely mirrors the motion of a robotic gripper. When the levers are pressed together, the internal transmission converts that motion (e.g., via sliding elements that cooperate with gear racks and a circular gear) into compact, repeatable movement of the gripper arms. This geometry yields a direct, intuitive mapping between human squeeze and gripper closure, improving control fidelity and timing.

The device incorporates a full suite of sensors that together provide comprehensive, time-aligned data for downstream processing. For example, a vision sensor may capture imagery of the workspace, a position-tracking sensor may determine a six-degree-of-freedom pose of the handheld device, and a tactile sensor disposed on a gripper arm may measure contact forces during object interaction. These sensors can operate individually or in combination to generate rich multimodal datasets that reflect both user intent and object dynamics. The device includes ergonomic contact surfaces and low-mass gripper geometries that improve comfort during extended use. Together, the mechanical and sensing features enable intuitive operation and high-quality data capture that greatly improve user experience.

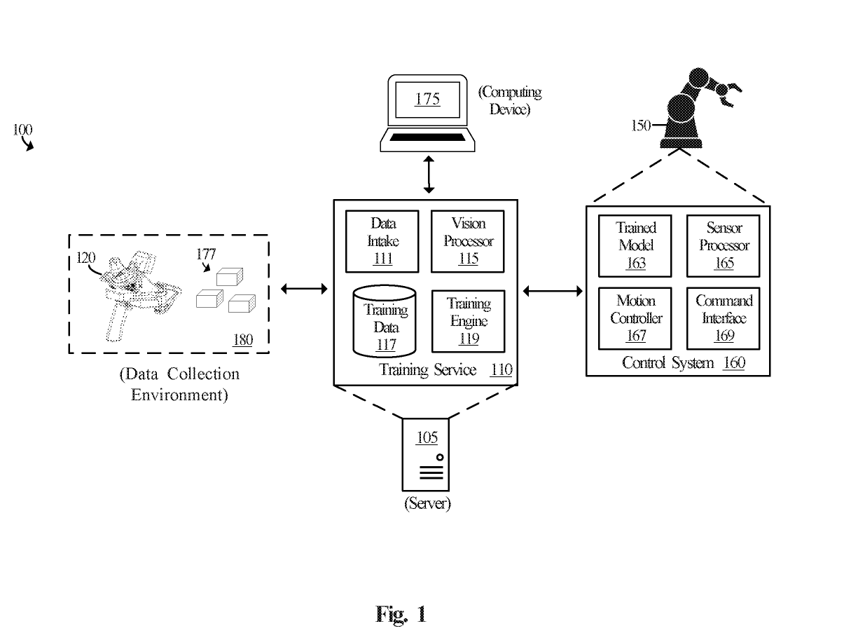

FIG. 1 illustrates robotic training system 100 in an implementation. Robotic training system 100 includes server 105, training service 110, data collection environment 180, robotic device 150, control system 160, and computing device 175.

Data collection environment 180 is representative of an environment in which robotic training data is collected. Data collection environment 180 includes handheld device 120 and training objects 177. However, it is noted that in various implementations, data collection environment 180 may include different or additional components not illustrated in FIG. 1 for clarity.

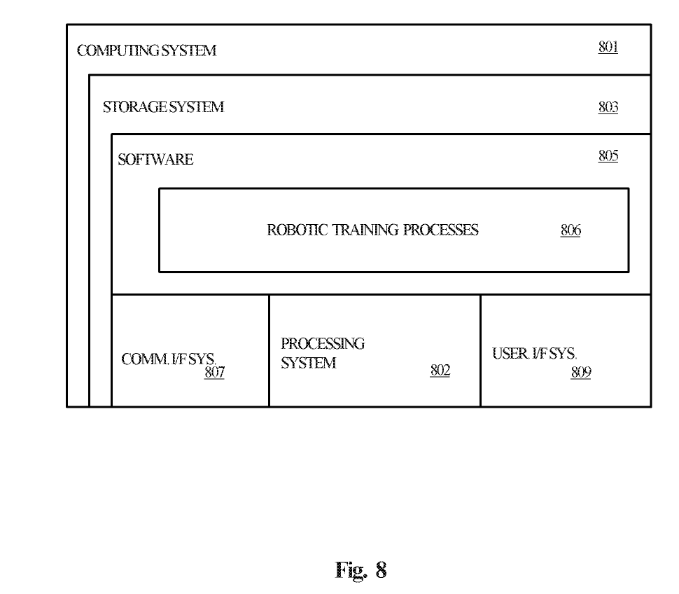

Handheld device 120 is representative of a device with a suite of integrated sensors and ergonomic features, as described in detail in the subsequent figures. By operating handheld device 120 to manipulate training objects 177, a user can generate diverse training scenarios while the integrated sensors capture relevant data (e.g., gripper state, positional information, and imagery). Handheld device 120 can communicate with training service 110 through various interfaces, such as Bluetooth or USB (e.g., connected to server 105 where training service 110 is implemented in server 105). In some implementations, handheld device 120 streams training data in real time to training service 110 for immediate processing. In other implementations, handheld device 120 temporarily stores the data locally (e.g., on an SD card in handheld device 120), then transfers it to training service 110 at a later time. Additional features and details of handheld device 120 are described in the figures that follow. Handheld device may include computing elements (as described for example in computing system 801 of FIG. 8) configured to collect data from the various sensors, store the data in memory and/or persistent storage, and transmit the data to training service 110.

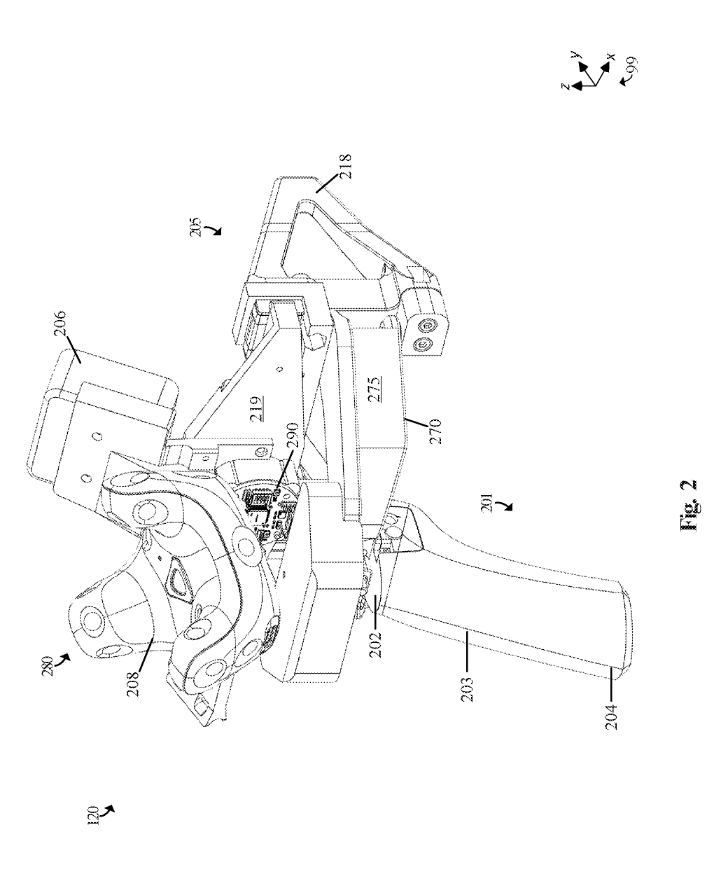

Training objects 177 are representative of any items a user may manipulate to generate robotic training data. These objects may include common household items such as cups, bowls, utensils, containers, tools, packaged goods, soft goods such as cloth or sponges, or task-oriented fixtures designed to encourage particular grasping or placement motions. In operation, a user may select one of the training objects, position handheld device 120 near the object, and squeeze the squeeze levers 270 (see FIG. 2) to close the end effector around it. The user may then lift, rotate, reorient, transfer, or place the object in various locations within data collection environment 180 to demonstrate manipulation behavior. As the user performs these actions, the sensors integrated into the handheld device capture multimodal information reflecting both the movement of the device and the interaction between the end effector and the object. These demonstrations may be repeated with different training objects, object orientations, or task steps to produce a diverse and comprehensive dataset suitable for training robotic models (e.g., in training service 110).

Training service 110 represents a system or platform for processing training data and producing models to be deployed on robotic device 150. FIG. 1 illustrates training service implemented on server 105. Server 105 represents a server for storing training data 117 and executing data intake 111, vision processor 115, and training engine 119. Server 105 may be represented by computing system 801 of FIG. 8. However, it is noted that in some implementations, training service 110 may be implemented in multiple servers or computing devices, or as a cloud-based service.

Data intake 111 is representative of a software service for intaking and processing training data from data collection environment 180. In some implementations, Data intake 111 processes incoming data by correlating different sensor streams (e.g., position data and encoder readings) by aligning their timestamps. Data intake 111 may also perform various calibration and filtering steps, such as transforming sensor outputs into a common coordinate frame, applying noise reduction or outlier detection, and annotating or compressing the training data. Processed data is then stored in training data 117. In some implementations, raw data from data collection environment may also be stored in training data 117 for later analysis or reprocessing.

Training data 117 is representative of a data repository storing processed training data and/or raw training data originating from data collection environment 180. Training data 117 may reside on computing device 175, on an external server, or within a cloud-based storage service. Training data 117 is provided to training engine 119 to develop models deployable on robotic device 150, as discussed further below. In some implementations, training data 117 may also be sold, licensed, or otherwise made available to third parties for their own robotic training purposes. In addition, training data 117 may include automatically generated or user-generated annotations. For instance, a user on computing device 175 could label specific sequences with the task being performed (e.g., “picking up a glass”).

Vision processor 115 is representative of a software service that processes images or video collected from data collection environment 180. In some implementations, vision processor 115 may include or interface with a machine-learning model configured to identify objects, extract features, or perform segmentation in the imagery. The resulting features can be utilized by training engine 119 to train models for robotic device 150, as described further below.

Training engine 119 is representative of a software service for training models for robotic devices, including, for example, the trained model 163 of robotic device 150. In various implementations, training engine 119 trains diffusion models or other machine-learning models employed by control system 160 to enable autonomous operation of robotic device 150. To facilitate this, training engine 119 can utilize features produced by vision processor 115 (e.g., object detections or segmentations), together with other sensor data (e.g., rotation angle readings, tactile force measurements, and positional tracking) to form multi-modal feature vectors for training artificial intelligence models. Artificial intelligence models trained by training engine 119 may then be deployed to robotic device 150 for real-time control (as represented by trained model 163 of control system 160).

Computing device 175 is representative of a computing device by which a user can interface with training service 110. For example, a user may annotate training data 117 via a user interface of computing device 175. Computing device 175 may be a personal computer, laptop, mobile device, tablet, etc. Computing device 175 may be represented by computing system 801 of FIG. 8.

Robotic device 150 is representative of a robotic device that utilizes trained model 163 in the execution of control decisions. Examples of robotic device 150 includes robotic arms (e.g., in industrial settings), humanoid robots for service tasks, and mobile robots performing deliveries, among other examples. Robotic device 150 includes control system 160, which may be implemented within an internal computing system (e.g., computing system 801 of FIG. 8). Robotic device 150 may be equipped with various sensors, such as vision sensors, rotation angle sensors for joint angles, or tactile sensors, to provide real-time feedback on the state of robotic device 150 and the surroundings of robotic device 150. In addition, robotic device 150 includes actuators (e.g., motors, servos) that drive joints and links, as well as an end effector (e.g., a gripper or suction device) for manipulating objects. In some implementations, the end effector of handheld device 120 is mechanically or functionally identical to the end effector of robotic device 150, providing that data collected by handheld device 120 mimics the robotic device’s actual operations.

Control system 160 represents a control center managing sensing, decision-making, and actuation for robotic device 150. Control system 160 includes trained model 163, sensor processor 165, motion controller 167, and command interface 169. It is noted that in various implementations, control system 160 may include additional or alternative elements not shown in FIG. 1 for the sake of clarity.

Trained model 163 is representative of an artificial intelligence model, such as a diffusion model, trained by training engine 119. Trained model 163 receives feature vectors that may be generated at least in part by sensor processor 165. For instance, sensor processor 165 can combine and filter data from the robotic device’s sensors (e.g., camera images, joint encoders), producing consolidated inputs. Trained model 163 then outputs inferences that capture high-level decisions, such as predicted trajectories of robotic device 150 or a predicted next state of robotic device 150, which are used by motion controller 167 to guide robotic movements.

Motion controller 167 is control software that makes control determinations based on inferences from trained model 163. By incorporating feedback from sensors and higher-level guidance (e.g., predicted trajectories and predicted next states) from trained model 163, motion controller 167 may determine specific joint angles, velocities, or forces needed to execute tasks such as picking up an item or navigating an environment.

Command interface 169 is responsible for translating the determinations from motion controller 167 into actuation commands. Command interface 169 provides commands to actuators of robotic device 150 (e.g., motors and servos).

FIG. 2 illustrates handheld device 120 in an implementation. Handheld device 120 includes handle 201, squeeze levers 270, end effector 205, and sensor module 280. It is noted that, while one squeeze lever 270 is visible in the angle in FIG. 2, handheld device 120 includes two squeeze levers 270, symmetrically arranged on opposite sides of handle 201, as shown more clearly in subsequent figures. Components of handheld device 120 may be formed from various materials, including plastics, metals, composite materials, or combinations thereof.

FIG. 2 and other figures of the present disclosure illustrate coordinate system 99 for reference when describing orientations and directions of components of handheld device 120. In the illustrated coordinate system 99, the y-axis extends generally forward from backplate 219 toward the end effector and gripper arms 218. The x-axis extends laterally toward the right side of the handheld device when viewed from the perspective of the backplate. The z-axis extends generally upward relative to the handheld device and is orthogonal to the x-axis and y-axis.

Coordinate system 99 is provided for descriptive convenience when explaining spatial relationships between components. Directions associated with the coordinate axes may therefore be described relative to handheld device 120 rather than relative to an external reference such as gravity. Accordingly, the z-axis may be described as a vertical direction with respect to the handheld device even though handheld device 120 may be moved, rotated, or oriented during operation.

Handle 201 forms a grip for a user during data collection. Handle 201 includes bottom end 204, contoured contact surface 203, and top end 202, which serves as a mounting location for squeeze levers 270. Contoured contact surface 203 is shaped to fit naturally within a user’s palm and fingers and may be configured to reduce pinch forces, fatigue, and hand strain during extended data-collection sessions. The cooperation of contact surface 203 and lever contact surfaces 275 enables a grasp posture in which the thumb and fingers move toward one another with reduced wrist deviation, improving comfort and repeatability during extended data-collection sessions.

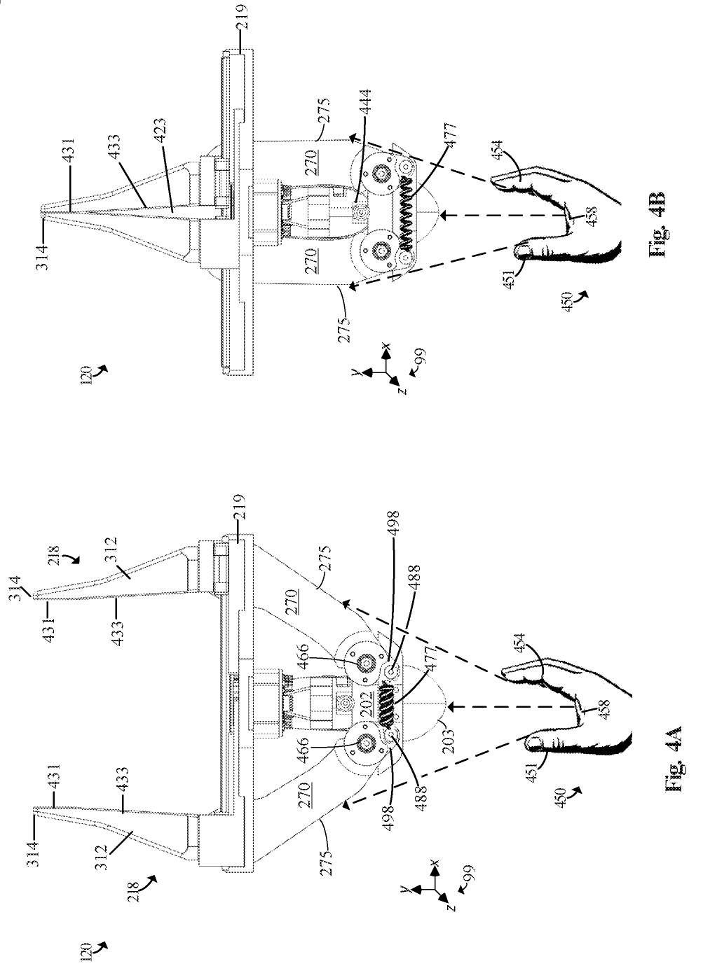

Each squeeze lever 270 extends between top end 202 of handle 201 and end effector 205. Squeeze levers 270 include lever contact surfaces 275 configured to engage with one or more fingers or a thumb of a user. The contact surfaces 275 may be curved or contoured to accommodate natural finger placement. As illustrated in FIGS. 4A and 4B, the arrangement of squeeze levers 270 allows a user to actuate the device using a natural grasping motion in which the thumb and fingers move toward one another in a generally U-shaped configuration. This ergonomic configuration allows users to generate smooth and repeatable actuation with reduced wrist deviation and improved comfort compared to trigger-based or button-based actuation mechanisms. As squeeze levers 270 are used for actuation of end effector 205, device 120 does not include a trigger or button-actuation method in some implementations.

End effector 205 includes one or more gripper arms 218 configured to grasp or release training objects. Only one gripper arm 218 is visible in the perspective view of FIG. 2; however, handheld device 120 includes two gripper arms 218 (also referred to as a first gripper arm and a second gripper arm) that move relative to one another between open and closed positions. Movement of squeeze levers 270 is translated through an internal mechanical linkage to cause corresponding movement of gripper arms 218. Additional details of this mechanical linkage are described in connection with later figures.

Sensor module 280 includes a collection of sensing components integrated into handheld device 120. In the illustrated implementation, sensor module 280 includes vision sensor 206, position sensor 208, rotary encoder 290, and tactile sensor 555, among others. These sensors generate multimodal data streams that may include imagery of the surrounding environment, position and orientation of handheld device 120, measurements of end-effector state, and contact forces experienced during grasping.

Vision sensor 206 may include a camera or other imaging device configured to capture still images or video of a training environment while the user manipulates objects with handheld device 120. Position sensor 208 may include one or more tracking components configured to determine a position and orientation of handheld device 120 in space. For example, position sensor 208 may include inertial measurement units (IMUs), optical tracking components, or other spatial tracking technologies.

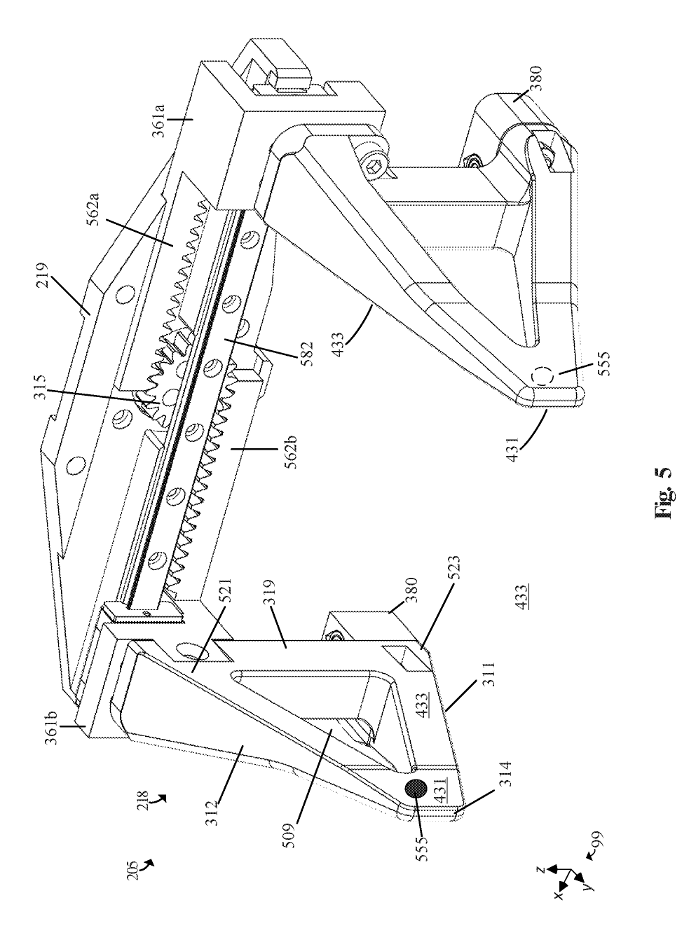

Rotary encoder 290 may be mechanically coupled to a component of the actuation mechanism associated with end effector 205 in order to measure a position of gripper arms 218 or a state of end effector 205. Tactile sensor 555 (of FIG. 5) may be disposed on or near one or more gripper arms 218 to measure forces applied during interaction with objects. Data generated by these sensors may be time-aligned and recorded to produce structured training data for robotic learning systems.

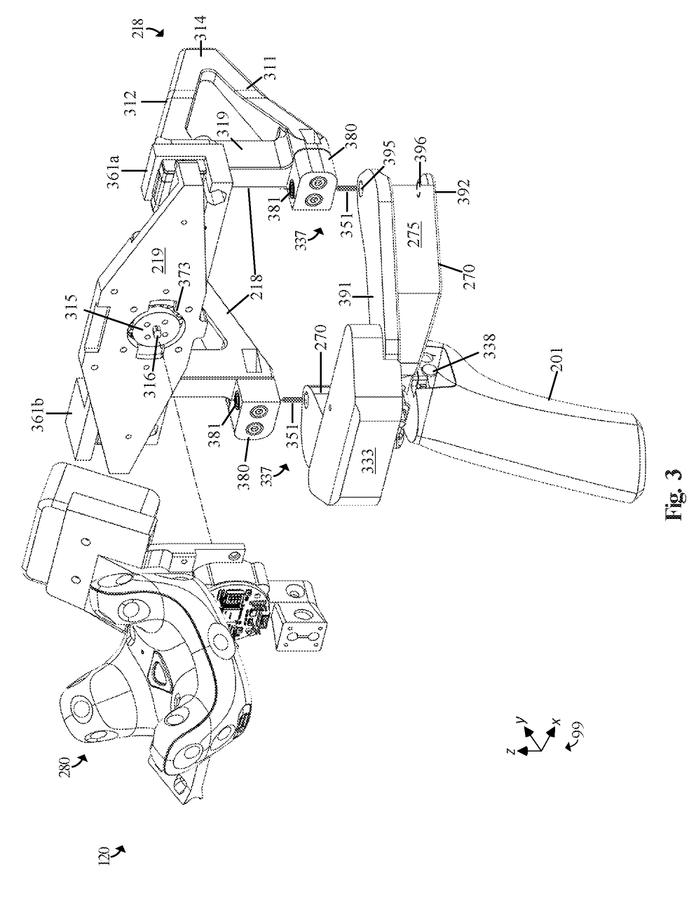

FIG. 3 illustrates an exploded view of the handheld device 120. Handheld device 120 includes handle 201, squeeze levers 270, backplate 219, gripper arms 218, sliding elements 361a and 361b, circular gear 315, gear shaft 316, and sensor module 280. Several components of handheld device 120 are discussed above with respect to FIG. 2. Various additional features illustrated in FIG. 3 are discussed in further detail below.

Handle 201 forms the primary gripping structure of handheld device 120. Squeeze levers 270 are positioned on opposite sides of handle 201 and are configured to be actuated by a user squeezing the levers toward one another. Each squeeze lever 270 may include structural plates such as top plate 391 and bottom plate 392. Lever contact surfaces 275 provide ergonomic engagement surfaces for the user’s fingers or thumb during operation. In some implementations, a bias element may urge the squeeze levers toward an open position, and cover 333 may enclose or protect portions of a biasing spring (shown more clearly in FIGS. 4A and 4B).

Each squeeze lever 270 is mechanically coupled to a corresponding gripper arm 218 through a rotatable coupling. In the illustrated implementation, flange 380 and associated rotational joints 337 (also referred to as a third rotational joint and a fourth rotational joint or rotational fasteners) provide a rotational connection between a squeeze lever 270 and a respective gripper arm 218. Through this connection, movement of the squeeze levers 270 is translated into motion of the gripper arms 218.

End effector components are supported by backplate 219. Gripper arms 218 extend from backplate 219 and are configured to move relative to one another to grasp or release objects. Each gripper arm 218 may include a tip portion 314, a vertical portion 319, a first angled portion 312 extending between the vertical portion and the tip portion, and a second angled portion 311 extending between the vertical portion and the tip portion. These geometric features may provide structural rigidity while maintaining a lightweight structure suitable for handheld operation.

Movement of squeeze levers 270 is translated to the gripper arms through sliding elements 361a and 361b. Sliding elements 361a and 361b are positioned near backplate 219 and are configured to move relative to the backplate in response to actuation of the squeeze levers. Sliding elements 361a and 361b are slidably coupled to backplate 219 and fixedly attached to respective gripper arms 218 in some implementations. Through this arrangement, actuation of squeeze levers 270 produces translation of gripper arms 218 and sliding elements 361a, 361b relative to backplate 219, which in turn causes circular gear 315 to rotate for position tracking of end effector 205.

Circular gear 315 is positioned between sliding elements 361a and 361b. Circular gear 315 is coupled to gear shaft 316, which rotates together with the circular gear. Backplate 219 includes opening 373 through which circular gear 315 and shaft 316 extends. Rotation of gear shaft 316 through opening 373 provides a rotational output that may be measured by a rotary encoder, such as rotary encoder 290 described with respect to FIG. 2.

Sensor module 280 may be mounted to backplate 219 or another portion of handheld device 120 and may house one or more sensing components for collecting robotic training data, as discussed above with respect to FIG. 2.

In some implementations, squeeze lever 270 may be rotatably coupled to gripper arm 218 through a pivot assembly. For example, flange 380 of gripper arm 218 may include opening 381 configured to receive pivot pin 351. Top plate 391 of squeeze lever 270 may include opening 395 and bottom plate 392 may include opening 396. Pivot pin 351 may extend through opening 381 of flange 380 and through openings 395 and 396 of the squeeze lever plates (with flange 380 disposed between top plate 391 and bottom plate 392), thereby forming rotational joints 337 (also referred to as a third rotational joint and a fourth rotational joint) that allow squeeze lever 270 to rotate relative to gripper arm 218 during actuation of the handheld device.

In some implementations, handheld device 120 may further include a user-actuatable button 338 positioned near top end 202 of handle 201. Button 338 may be configured to initiate, mark, or otherwise control collection of robotic training data during operation of the device. For example, a user may press button 338 to begin recording sensor data generated by sensors of sensor module 280, such as vision sensor 206, position sensor 208, rotary encoder 290, or tactile sensors 555. In some implementations, button 338 may also be used to mark segments of collected training data, trigger event annotations, or control other data-collection functions. Button 338 may be positioned near the top end of handle 201 to allow convenient actuation by a user while gripping the handle and operating squeeze levers 270.

FIGS. 4A and 4B illustrate handheld device 120 in an open position and a closed position, respectively. As described above, handheld device 120 includes backplate 219 supporting gripper arms 218 and squeeze levers 270. Squeeze levers 270 extend from top end 202 of the handle and include lever contact surfaces 275 configured to be engaged by a user’s hand 450 during operation.

In FIG. 4A, handheld device 120 is shown in an open position in which gripper arms 218 are separated from one another. In this configuration, squeeze levers 270 are positioned outward relative to handle 201. Each squeeze lever 270 is rotatably coupled about a respective rotational joint 466 (also referred to as a first rotational joint and a second rotational joint). Bias spring 477 is coupled to pins 488 on bias extensions 498 of the squeeze levers 270 and urges the squeeze levers outward, thereby biasing gripper arms 218 toward the open position when a user is not actively applying force to the levers. Each squeeze lever 270 is rotatably coupled to top end 202 of handle 201 about a respective rotational joint 466 (e.g., a first rotational joint for a first lever and a second rotational joint for a second lever), allowing the levers to rotate inward during grasp and return outward under the influence of bias spring 477.

FIG. 4B illustrates handheld device 120 in a closed position. When a user squeezes squeeze levers 270 toward one another, the levers rotate about rotational joints 466 against the bias of spring 477. This motion actuates the end effector such that gripper arms 218 move toward one another until contact surfaces 431 of tip portions 314 engage an object or approach one another in the closed configuration.

FIGS. 4A and 4B further illustrate a hand 450 positioned to actuate handheld device 120. Hand 450 includes thumb 451, fingers 454, and palm 458. During operation, thumb 451 and fingers 454 may engage lever contact surfaces 275 while palm 458 engages contact surface 203 of the handle. As the user performs a natural grasping motion, the thumb and fingers move toward one another in a generally U-shaped configuration, causing squeeze levers 270 to rotate about rotational joints 466 and actuate gripper arms 218. This configuration provides a direct correspondence between a human grasping motion and actuation of the gripper arms, allowing users to generate intuitive and repeatable demonstrations during robotic training data collection.

The depiction of hand 450 in FIGS. 4A and 4B is provided for illustrative purposes to demonstrate the ergonomic relationship between the user’s hand and squeeze levers 270. The illustrated hand is not necessarily drawn to scale relative to handheld device 120 and may represent only one possible hand position during operation.

Each gripper arm 218 includes tip portion 314 having contact surface 431, together with oblique surfaces 433 extending along portions of the gripper arm structure. In some implementations, oblique surfaces 433 are oriented at an oblique angle relative to contact surfaces 431. The relative orientation of these surfaces forms gap 423 between the gripper arms when the device is in a closed configuration. Gap 423 may be produced by the relative orientation of oblique surfaces 433 and other portions of the gripper arms, thereby providing a special geometry that enhances the ability to pick up objects of varying sizes and shapes with handheld device 120.

FIG. 5 illustrates end effector 205 of handheld device 120 according to an implementation. End effector 205 includes backplate 219, gripper arms 218, sliding elements 361a and 361b, circular gear 315, and gear racks 562a and 562b. In the illustrated implementation, gripper arms 218 are supported relative to backplate 219 and are configured to move toward and away from one another in response to actuation of the squeeze levers, as described with respect to previous figures.

Each gripper arm 218 includes tip portion 314, vertical portion 319, and angled portions including first angled portion 312 and second angled portion 311. Tip portion 314 includes contact surface 431 configured to engage an object during grasping. Angled surface 433 may extend along portions of the angled portions and vertical portion of gripper arm 218. The relative geometry of these portions may form gap 509 within the gripper arm structure. Gap 509 may reduce material usage and weight while maintaining structural rigidity suitable for repeated manipulation operations.

Vertical portion 319 of each gripper arm includes upper portion 521 and lower portion 523. Upper portion 521 is configured to engage sliding elements 361a and 361b, while lower portion 523 is configured to engage flange 380 that provides a rotatable coupling between the gripper arms and the squeeze levers. Through this arrangement, movement of the squeeze levers may be translated into motion of the gripper arms relative to backplate 219.

Sliding elements 361a and 361b are positioned adjacent to backplate 219 and are configured to translate relative to the backplate. In the illustrated implementation, sliding elements 361a and 361b include gear racks 562a and 562b that engage circular gear 315. Translation of sliding elements 361a and 361b causes rotation of circular gear 315, thereby coordinating motion of the gripper arms. Guide rib 582 may extend along a portion of the transmission assembly to guide movement of the sliding elements and maintain alignment during operation.

In some implementations, each sliding element 361a and 361b may be fixedly attached to a respective gripper arm 218 such that translation of the sliding elements produces corresponding movement of the gripper arms. For example, sliding element 361a may be coupled to a first gripper arm 218 and sliding element 361b may be coupled to a second gripper arm 218. The sliding elements may be formed integrally with the gripper arms or may be attached using fasteners, bolts, adhesives, press-fit connections, or other mechanical attachment techniques. Through this arrangement, movement of squeeze levers 270 may be transmitted through the mechanical linkage to translate sliding elements 361a and 361b relative to backplate 219, thereby producing coordinated motion of the gripper arms between open and closed positions.

In some implementations, tactile sensors 555 may be disposed on or near tip portions 314 of the gripper arms. Tactile sensors 555 may measure contact forces applied to objects during grasping operations. Data generated by tactile sensors 555 may be combined with other sensor data collected by handheld device 120 to produce multimodal training data suitable for robotic learning systems. In this manner, the actuation of squeeze levers 270 by a user’s natural grasping motion is mechanically translated through sliding elements 361a and 361b and gear racks 562a and 562b into coordinated movement of gripper arms 218, while sensors of handheld device 120 capture multimodal data describing the resulting manipulation of objects.

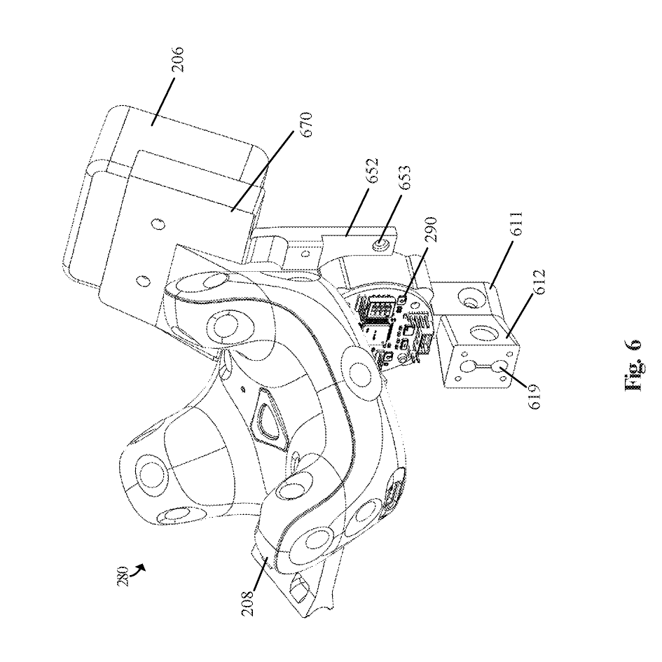

FIG. 6 illustrates sensor module 280 of handheld device 120 according to an implementation. Sensor module 280 may include one or more sensing components configured to collect robotic training data during operation of the handheld device. In the illustrated implementation, sensor module 280 includes vision sensor 206, position sensor 208, and rotary encoder assembly 290.

Sensor module 280 may include attachment plate 652 configured to attach to backplate 219 of the end effector assembly. In some implementations, attachment plate 652 may be directly coupled to backplate 219 using one or more mounting holes 653. Through this arrangement, sensor module 280 may be rigidly coupled to the end effector structure while the gripper arms move relative to the backplate during actuation. An angled mount 670 may extend from attachment plate 652 and support vision sensor 206. Angled mount 670 may position vision sensor 206 at a desired orientation relative to handheld device 120, allowing the vision sensor to capture imagery of objects manipulated by gripper arms 218 and the surrounding training environment.

Position sensor 208 is fixedly attached to attachment plate 652, for example via one or more bolts or the like. Sensor module 280 may further include extension 611 extending from the module structure. Rotary encoder 290 is also fixedly attached to attachment plate 652, while attachment plate 652 may include a through hole configured to receive output shaft 316 for effector position sensing by rotary encoder 290. Mounting protrusion 612 may extend from extension 611 and may include one or more mounting holes 619 configured to attach sensor module 280 to the top end of the handle. In some implementations, mounting holes 619 may be configured to couple with attachment extension 444 of the handle, as described with respect to FIG. 4B.

Through this arrangement, handle 201, sensor module 280, and the associated mounting structures may be fixed relative to one another to form a stationary frame of handheld device 120. Sensors supported by sensor module 280 may therefore measure motion of handheld device 120 and interactions of gripper arms 218 while the gripper arms articulate relative to the stationary frame.

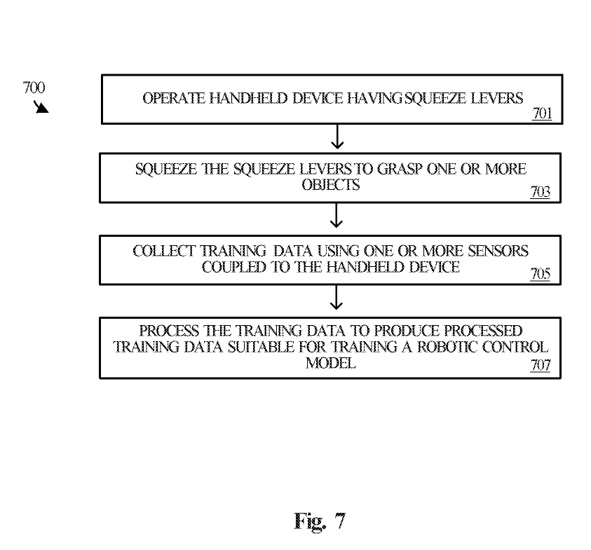

FIG. 7 illustrates a robotic training process performed in the context of robotic training system 100 of FIG. 1, represented by process 700.

At step 701, a user operates handheld device 120 to perform manipulation actions within a training environment. As described with respect to previous figures, handheld device 120 includes squeeze levers 270, end effector 205 having gripper arms 218, and one or more sensors of sensor module 280. During operation, the user may position handheld device 120 near an object and prepare the device for grasping.

At step 703, the user squeezes squeeze levers 270 to actuate end effector 205 and grasp one or more objects. In some implementations, squeezing squeeze levers 270 causes gripper arms 218 to move toward one another to engage an object, while releasing the levers allows the gripper arms to return toward an open position.

At step 705, training data is collected using one or more sensors coupled to handheld device 120. For example, vision sensor 206 may capture imagery of the training environment, position sensor 208 may capture position and orientation information associated with handheld device 120, rotary encoder 290 may capture information describing actuation of end effector 205, and tactile sensors 555 may capture force measurements during grasping. These sensor measurements may be time-stamped and recorded as multimodal training data.

At step 707, the collected training data may be processed to produce processed training data suitable for training a robotic control model. In some implementations, this processing may include filtering, synchronization of sensor streams, feature extraction, or other preprocessing operations performed by components of robotic training system 100, such as training service 110 described with respect to FIG. 1.

FIG. 8 illustrates computing system 801, which is representative of any system or collection of systems in which the various applications, processes, services, and scenarios disclosed herein may be implemented. Examples of computing system 801 include, but are not limited to server computers, web servers, cloud computing platforms, and data center equipment, as well as any other type of physical or virtual server machine, container, and any variation or combination thereof. (In some examples, computing system 801 may also be representative of desktop and laptop computers, tablet computers, and the like.)

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes and implements robotic training processes 806, which is representative of the processes discussed with respect to the preceding Figures, such as process 700. When executed by processing system 802, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may include a microprocessor and other circuitry that retrieves and executes software 805 from storage system 803. Processing system multiple processing devices or sub-systems that cooperate in executing program instructions. Examples of processing system 802 include general purpose central processing units, microcontroller units, graphical processing units, application specific processors, integrated circuits, application specific integrated circuits, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 803 may be implemented as a single storage device but may also be implemented across multiple storage devices or sub-systems co-located or distributed relative to each other. Storage system 803 may comprise additional elements, such as a controller capable of communicating with processing system 802 or possibly other systems.

Software 805 (including robotic training processes 806) may be implemented in program instructions and among other functions may, when executed by processing system 802, direct processing system 802 to operate as described with respect to the various operational scenarios, sequences, and processes illustrated herein. For example, software 805 may include program instructions for implementing resource management processes and procedures as described herein.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number respectively. The word "or," in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for", but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A device for robotic training data collection comprising:
an end effector configured to grasp objects during collection of robotic training data;
a first squeeze lever and a second squeeze lever each mechanically coupled to the end effector and configured such that hand-squeezing the first squeeze lever and the second squeeze lever together and apart moves the end effector between an open position and a closed position; and
a sensor module coupled to the end effector, the sensor module comprising one or more sensors configured to collect the robotic training data.

2. The device of claim 1, further comprising a handle having a bottom end and a top end, wherein the first squeeze lever is rotatably coupled to the top end and extends between the top end and a first lateral side of the end effector, and wherein the second squeeze lever is rotatably coupled to the top end and extends between the top end and a second lateral side of the end effector.

3. The device of claim 2, wherein the first squeeze lever comprises a first engagement surface configured to engage with a finger or thumb, and the second squeeze lever comprises a second engagement surface configured to engage with a different finger or thumb such that a user actuates the end effector by squeezing the first squeeze lever and the second squeeze lever together while a palm engages the handle.

4. The device of claim 2, further comprising a user-actuatable button disposed at the top end of the handle and configured to initiate data collection.

5. The device of claim 2, wherein the first squeeze lever is rotatably coupled to the top end of the handle via a first rotational joint and the second squeeze lever is rotatably coupled to the top end of the handle via a second rotational joint.

6. The device of claim 5, wherein
the end effector comprises:
a first gripper arm rotatably coupled to the first squeeze lever at a third rotational joint;
a second gripper arm rotatably coupled to the second squeeze lever at a fourth rotational joint; and
a backplate slidably coupled to the first gripper arm and the second gripper arm such that rotation of the first squeeze lever causes translation of the first gripper arm and rotation of the second squeeze lever causes translation of the second gripper arm relative to the backplate.

7. The device of claim 6, wherein each of the first gripper arm and the second gripper arm comprises:
a tip portion,
a vertical portion,
a first angled portion extending from a top of the vertical portion to the tip portion, and
a second angled portion extending from a bottom of the vertical portion to the tip portion.

8. The device of claim 7, wherein the tip portion of the first gripper arm comprises a first contact surface and the tip portion of the second gripper arm comprises a second contact surface substantially parallel to the first contact surface such that the first contact surface is flush with the second contact surface when the end effector is in the closed position.

9. The device of claim 8, wherein, for each of the first gripper arm and the second gripper arm:
the vertical portion, the first angled portion, and the second angled portion form an oblique surface at an oblique angle with respect to the respective contact surfaces, thereby forming a gap between the first gripper arm and the second gripper arm when the end effector is in the closed position.

10. The device of claim 7, wherein each of the first gripper arm and the second gripper arm comprises a gap formed by the tip portion, the vertical portion, the first angled portion and the second angled portion, thereby providing a lightweight design for collection of the robotic training data.

11. The device of claim 7 wherein the first gripper arm and the second gripper arm each comprise a flange extending from the bottom end of the vertical portion configured to rotatably couple to the respective squeeze lever.

12. The device of claim 7, wherein the end effector further comprises:
a first sliding element attached to a top end of the vertical portion of the first gripper arm,
a first gear rack extending from the first sliding element and integral to the first sliding element,
and a second sliding element attached to a top end of the vertical portion of the second gripper arm,
a second gear rack extending from the second sliding element and integral to the second sliding element,
a circular gear configured to engage with the first gear rack and the second gear rack such that, when the end effector moves between the open position and the closed position, translation of the first gripper arm and the second gripper arm cause rotation of the circular gear.

13. The device of claim 12, wherein the one or more sensors comprise a rotary encoder coupled to the circular gear thereby tracking a position of the end effector based on rotation of the circular gear.

14. The device of claim 1, further comprising a spring mechanically coupling a bias extension of the first squeeze lever to a bias extension of the second squeeze lever, wherein the spring is configured to bias the first squeeze lever and the second squeeze lever toward an open position of the end effector.

15. The device of claim 1, wherein the one or more sensors comprise at least one of:
a vision sensor configured to capture imagery of a training environment;
a position tracking sensor configured to capture a position and orientation of the device;
a rotary encoder configured to capture a position of the end effector; and
a tactile sensor disposed on the end effector and configured to measure force applied during grasping.

16. The device of claim 1, wherein actuation of the end effector is performed by the first squeeze lever and the second squeeze lever, and the device does not include a trigger.

17. A system for robotic training data collection comprising:
a handheld device comprising:
an end effector configured to grasp objects;
a first squeeze lever and a second squeeze lever each mechanically coupled to the end effector and configured such that squeezing the first squeeze lever and the second squeeze lever together and apart moves the end effector between an open and a closed position; and
a sensor module coupled to the end effector, the sensor module comprising one or more sensors configured to collect the robotic training data; and
a computing system configured to:
receive the training data from the handheld device;
process the training data to generate processed training data; and
train an artificial intelligence model using the processed training data.

18. The system of claim 17, wherein the one or more sensors comprise at least one of:
a vision sensor configured to capture imagery of a training environment;
a position tracking sensor configured to capture a position and orientation of the device;
a rotary encoder configured to capture a position of the end effector; and
a tactile sensor disposed on the end effector and configured to measure force applied during grasping.

19. The system of claim 17, wherein actuation of the end effector is performed by the first squeeze lever and the second squeeze lever, and the handheld device does not include a trigger.

20. A method for collecting robotic training data comprising:
operating a handheld device comprising a pair of squeeze levers mechanically coupled to an end effector;
squeezing the squeeze levers together and apart to actuate the end effector to grasp one or more objects;
collecting training data using one or more sensors coupled to the handheld device;
transmitting the training data to a computing system; and
processing the training data to produce processed training data suitable for training a robotic control model.
